(19) United States
(12) Patent Application Publication
(10) Pub. No.: US 2002/0076579 A1
(43) Pub. Date: Jun. 20, 2002

(54) Magnetic recording medium, production process thereof, magnetic recording and reproducing apparatus, and medium substrate

(75) Inventors: Kenzo Hanawa, Chiba (JP); Hiroshi Ohsawa, Chiba (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: SHOWA DENKO KABUSHIKI KAISHA

(21) Appl. No.: 09/983,944

(22) Filed: Oct. 26, 2001

Related U.S. Application Data
(60) Provisional application No. 60/268,907, filed on Feb. 16, 2001.

(30) Foreign Application Priority Data
Oct. 27, 2000 (JP) P2000-329550

(51) Int. Cl. G11B 5/66

(52) U.S. Cl. 428/694 TS

(57) ABSTRACT

A magnetic recording medium which exhibits excellent magnetic characteristics and realizes high recording density comprises a non-magnetic substrate. A crystal-structure-regulating film, which regulates the crystal structure of a film provided directly thereon, is formed on the non-magnetic substrate A non-magnetic undercoat film and a magnetic film are formed on the crystal regulating film, and a soft magnetic film is provided between the non-magnetic substrate and the crystal-structure-regulating film. A process for producing the medium; a magnetic recording and reproducing apparatus including the medium; and a medium substrate used in the medium are also provided.

### CROSS REFERENCE TO RELATED APPLICATIONS

This application is an application filed under 35 U.S.C. §111(a) claiming benefit pursuant to 35 U.S.C. §119(e)(1) of the filing date of Provisional Application 60/268,907 filed Feb. 16, 2001 pursuant to 35 U.S.C. §111(b).

### FIELD OF THE INVENTION

The present invention relates to a magnetic recording medium used in an apparatus such as a magnetic disk apparatus; a process for producing the magnetic recording medium; a magnetic recording and reproducing apparatus including the magnetic recording medium; and a medium substrate used in the magnetic recording medium.

### BACKGROUND OF THE INVENTION

Conventional magnetic recording media include a magnetic recording medium in which a crystal-structure-regulating film of, for example, NiP or NiAl is formed on a non-magnetic substrate, and a non-magnetic undercoat film and a magnetic film are formed on the crystal-structure-regulating film.

In recent years, there has been demand for magnetic recording media of higher recording density, and in accordance with this trend, improvements to read-write conversion characteristics and thermal stability have been required. In order to enhance such read-write conversion characteristics and thermal stability, there have been proposed magnetic recording media including a soft magnetic film formed from a soft magnetic material.

Examples of the magnetic recording media containing a soft magnetic film include a magnetic recording medium in which a soft magnetic film is provided on a magnetic film; a magnetic recording medium in which a soft magnetic film is provided between a non-magnetic undercoat film and a magnetic film; and a magnetic recording medium in which a soft magnetic film is provided between a crystal-structure-regulating film and a non-magnetic undercoat film.

However, the conventional magnetic recording medium in which a soft magnetic film is provided on a magnetic film encounters difficulty in attaining high recording density, since the distance between the magnetic film and a magnetic head (i.e., spacing loss) becomes large during recording or reproduction of data.

The conventional magnetic recording medium in which a soft magnetic film is provided between a non-magnetic undercoat film and a magnetic film involves no problem in terms of spacing loss. However, since the soft magnetic film adversely affects crystal growth of the magnetic film during film formation, the crystal orientation of the magnetic film becomes unsatisfactory. As a result, magnetic characteristics of the magnetic recording medium are deteriorated.

In the conventional magnetic recording medium in which a soft magnetic film is provided between a crystal-structure-regulating film and a non-magnetic undercoat film, since the soft magnetic film adversely affects crystal growth of the non-magnetic undercoat film during film formation, a magnetic film, which is grown under the effect of the undercoat film, attains an unsatisfactory crystal orientation. As a result, magnetic characteristics of the magnetic recording medium are deteriorated.

### SUMMARY OF THE INVENTION

In view of the foregoing, an object of the present invention is to provide a magnetic recording medium which exhibits excellent magnetic characteristics and realizes high recording density.

Another object of the present invention is to provide a process for producing such a medium.

A further object of the present invention is to provide a magnetic recording and reproducing apparatus including such a medium.

A still further object of the present invention is to provide a medium substrate used in such a medium.

To achieve the foregoing objects and in accordance with its purpose, the present invention provides a magnetic recording medium that has a soft magnetic film between a non-magnetic substrate and a crystal-structure-regulating film.

Preferably, the crystal-structure-regulating film is formed from NiP or NiAl.

Preferably, the soft magnetic film has a multi-layer structure containing a plurality of soft magnetic layers and a plurality of non-magnetic layers.

The soft magnetic film may contain a soft magnetic layer and a hard magnetic layer.

In the magnetic recording medium of the present invention, the non-magnetic substrate is formed from a non-metallic material, and a diffusion preventive film for preventing diffusion of the material of the non-magnetic substrate into the soft magnetic film may be provided between the non-magnetic substrate and the soft magnetic film.

The diffusion preventive film may have an amorphous structure.

The present invention also provides a process for producing a magnetic recording medium, which comprises forming a crystal-structure-regulating film on a non-magnetic substrate; forming a non-magnetic undercoat film and a magnetic film on the crystal-structure-regulating film, and providing a soft magnetic film between the non-magnetic substrate and the crystal-structure-regulating film.

The present invention also provides a magnetic recording and reproducing apparatus comprising a magnetic recording medium and a magnetic head for recording data onto the medium and reproducing the data therefrom, wherein the magnetic recording medium comprises a non-magnetic substrate; a crystal-structure-regulating film formed thereon, which film regulates the crystal structure of a film provided directly on the crystal-structure-regulating film; a non-magnetic undercoat film and a magnetic film formed on the crystal-structure-regulating film; and a soft magnetic film provided between the non-magnetic substrate and the crystal-structure-regulating film.

The present invention also provides a medium substrate comprising a non-magnetic substrate and a soft magnetic film provided thereon.

### BRIEF DESCRIPTION OF THE DRAWINGS

FIG. 1 is a partial cross-sectional view showing one embodiment of the magnetic recording medium of the present invention.

FIG. 2 is an enlarged view showing an essential portion of the magnetic recording medium shown in FIG. 1.

FIG. 3 is an enlarged view showing an essential portion of the magnetic recording medium shown in FIG. 1.

FIG. 4 is an enlarged view showing an essential portion of the magnetic recording medium shown in FIG. 1.

FIG. 5 is a partial cross-sectional view showing another embodiment of the magnetic recording medium of the present invention.

FIG. 6 is a partial cross-sectional view showing yet another embodiment of the magnetic recording medium of the present invention.

FIG. 7 is a partial cross-sectional view showing yet another embodiment of the magnetic recording medium of the present invention.

FIG. 8 is a partial cross-sectional view showing an embodiment of the magnetic recording and reproducing apparatus of the present invention.

### DETAILED DESCRIPTION OF THE PRESENT INVENTION

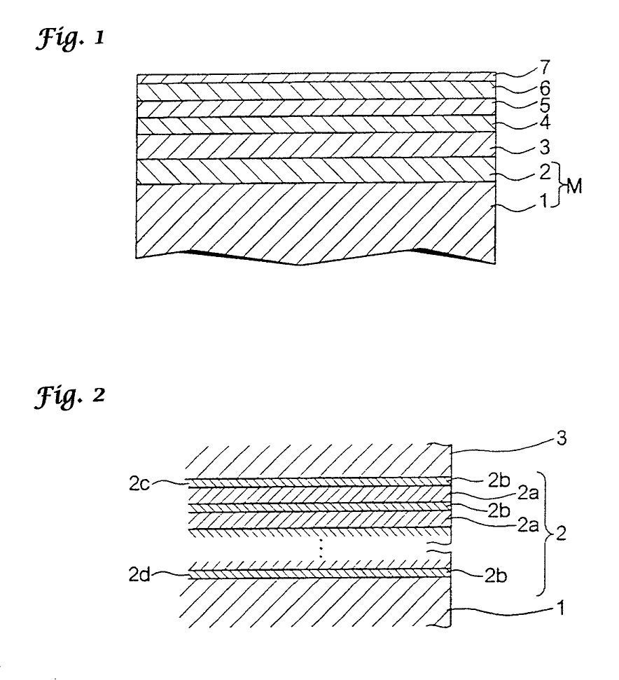

FIG. 1 shows an embodiment of the magnetic recording medium of the present invention. The magnetic recording medium includes a non-magnetic substrate 1, a soft magnetic film 2, a crystal-structure-regulating film 3, a non-magnetic undercoat film 4, a magnetic film 5, a protective film 6, and a lubrication film 7, the films 2 to 7 being successively formed on the substrate 1.

Hereinafter, the structure consisting of the non-magnetic substrate 1 and the soft magnetic film 2 will be called a medium substrate M.

The non-magnetic substrate 1 may be a metallic substrate formed from a metallic material such as aluminum or an aluminum alloy; or a non-metallic substrate formed from a non-metallic material such as glass, ceramic, silicon, silicon carbide, or carbon.

A glass substrate may be formed from amorphous glass or glass ceramic. The amorphous glass may be widely-used soda-lime glass, or aluminosilicate glass. The glass ceramic may be lithium-based glass ceramic.

Meanwhile, a ceramic substrate may be a widely-used sintered material predominantly containing, for example, aluminum oxide, aluminum nitride, or silicon nitride; or fiber-reinforced material thereof.

As shown in FIG. 2, the soft magnetic film 2 may have a multi-layer structure containing a plurality of soft magnetic layers 2a and a plurality of non-magnetic layers 2b. Preferably a soft magnetic film and a non-magnetic layer are multiplied alternately.

Any soft magnetic material can be used for forming the soft magnetic layer 2a. For example, a soft magnetic material containing Fe, Ni, or Co can be used.

Specific examples of the soft magnetic material include CoZr-based alloys (e.g., CoZr, CoZrNb, CoZrTa, CoZrCr, and CoZrMo); CoTaNb-based alloys; CoCr-based alloys; NiFe-based alloys (e.g., NiFe, NiFeMo, NiFeCr, and NiFeSi); NiCr-based alloys; FeAl-based alloys (e.g., FeAl, FeAlSi, FeAlSiCr, and FeAlSiTiRu); FeC-based alloys; FeSi-based alloys; FeP-based alloys; FeCr-based alloys (e.g., FeCr, FeCrTi, and FeCrCu); FeCo-based alloys (e.g., FeCo and FeCoV); FeTa-based alloys (e.g., FeTa and FeTaC); FeNb-based alloys; and FeHf-based alloys.

Of these, a CoZr-based alloy is preferably used. This is because a CoZr-based alloy becomes amorphous when the Zr content is at least 15 at%, and becomes non-magnetic when the Zr content is 50 at%; i.e., allowing desired properties of the CoZr-based alloy to be obtained through varying the composition. CoZr containing Zr in an amount of 15-45 at% may be used as the CoZr-based alloy.

When the soft magnetic layer 2a is very thin, magnetization of the layer becomes unsatisfactory, resulting in lowering of the effect of enhancing magnetic characteristics such as PW50 (half power width of output peak). In contrast, when the soft magnetic layer 2a is very thick, magnetic domain walls easily move in the layer 2a, and thus spike noise is prone to be generated.

Therefore, the thickness of the soft magnetic layer 2a is preferably 1-7 nm, more preferably 2-7 nm.

The non-magnetic layer 2b is provided for preventing magnetic bonding of two soft magnetic layers 2a located adjacent to the layer 2b so as to sandwich the layer 2b. Any non-magnetic material can be used for forming the non-magnetic layer 2b, but preferably, the material is chosen in accordance with the material of the soft magnetic layer 2a.

When the soft magnetic layer 2a is formed from a Co alloy, the non-magnetic layer 2b is preferably formed from a Co alloy. When the soft magnetic layer 2a is formed from an Ni alloy, the non-magnetic layer 2b is preferably formed from an Ni alloy.

For example, when the soft magnetic layer 2a is formed from a Co alloy (e.g., a CoZr-based alloy), the non-magnetic layer 2b may be formed from, for example, CoCr (Cr content: 35 at% or more), CoCrTa (Cr content: 35 at% or more, Ta content: 5-10 at%), or CoCrZr (Cr content: 35 at% or more, Zr content: 5-10 at%).

The reason why the material of the non-magnetic layer 2b is preferably chosen in accordance with the material of the soft magnetic layer 2a is that, even when the material of the non-magnetic layer 2b is diffused into the soft magnetic layer 2a, change in the composition of the material of the layer 2a can be minimized, and deterioration of magnetic characteristics of the layer 2a can be prevented.

In general, a Co alloy becomes non magnetic when the Co content is less than 50 at%. Therefore, the soft magnetic layer 2a may be formed from a Co alloy containing Co in an amount of more than 50 at%.

The non-magnetic layer 2b may be formed from a Cr alloy; for example, a CrTa-based alloy or a CrZr-based alloy.

The thickness of the non-magnetic layer 2b is preferably 2-7 nm, more preferably 2-4 nm. When the thickness is below the above range, magnetic bonding easily occurs between two soft magnetic layers 2a located adjacent to the layer 2b so as to sandwich the layer 2b, which may induce noise such as spike noise.

In contrast, when the thickness of the non-magnetic layer 2b exceeds the above range, the distance between the magnetic film 5 and the soft magnetic layer 2a located below the layer 2b becomes very large, and thus the effect of enhancing magnetic characteristics such as PW50 is lowered.

The uppermost layer of the soft magnetic film 2 may be the soft magnetic layer 2a or the non-magnetic layer 2b.

In the case in which the below-described crystal-structure-regulating film 3 is formed from NiP, and the film 3 is subjected to texturing, when the hardness of the uppermost layer of the soft magnetic film 2 is high, texturing of the film 3 can be carried out easily, and there can be prevented problems, including generation of large abrasive scars on the surface of the film 3 and remaining of abrasive grains on the surface.

Therefore, preferably, the uppermost layer of the soft magnetic film 2 is the non-magnetic layer 2b (i.e., the uppermost non-magnetic layer 2c), and the uppermost non-magnetic layer 2c is formed from a material of high hardness; for example, a CrTa-based alloy.

When the uppermost non-magnetic layer 2c is very thick, the distance between the soft magnetic layer 2a and the magnetic film 5 becomes very large, and the effect of enhancing magnetic characteristics such as PW50 is lowered. Therefore, the thickness of the layer 2c is preferably 5 nm or less.

When the crystal-structure-regulating film 3 is formed from an NiAl-based alloy, the uppermost layer of the soft magnetic film 2 is preferably formed from a material which can determine the crystal orientation of the NiAl-based alloy (for example, a material which can make the crystal orientation plane of NiAl assume a (112) plane).

The material may be a crystalline material or an amorphous material, but an amorphous material is preferred.

The material may be a CrTa-based alloy (e.g., Cr35Ta, Ta content: 35 at%), a CoZr-based alloy (e.g., Co66Zr, Zr content: 66 at%), or a CrSi-based alloy (e.g., Cr30Si, Si content: 30 at%).

The lowermost layer of the soft magnetic film 2 may be the soft magnetic layer 2a or the non-magnetic layer 2b.

When the non-magnetic substrate 1 is a non-metallic substrate formed from a non-metallic material such as glass, the lowermost layer of the soft magnetic film 2 is preferably the non-magnetic layer 2b (i.e., the lowermost non-magnetic layer 2d).

This is because, even when the material of the non-magnetic substrate 1 (e.g., oxygen) is diffused into the soft magnetic film 2 during film formation, invasion of the material into the soft magnetic layer 2a can be prevented, and adverse effects of the material on magnetic characteristics of the soft magnetic film 2 can be prevented.

The lowermost non-magnetic layer 2d is preferably formed from an amorphous material, since the effect of preventing invasion of the material of the substrate into the soft magnetic layer 2a can be enhanced.

No particular limitation is imposed on the number of the soft magnetic layers 2a and the non-magnetic layers 2b (i.e., the total of the number of the soft magnetic layers 2a and the number of the non-magnetic layers 2b ), but the total number is preferably 3 to 20.

The soft magnetic film 2 is formed from a material having a coercive force (Hc) of preferably 200 (Oe) or less (more preferably 150 (Oe) or less).

When the coercive force (Hc) exceeds the above range, the effect of enhancing magnetic characteristics such as PW50 is lowered.

The product of saturated magnetization and film thickness (Bsδ) of the soft magnetic film 2 is preferably 20-100 Gauss. μm (Gμm), more preferably 30-70 Gμm.

When Bsδ is below the above range, the magnetization of the soft magnetic film 2 becomes unsatisfactory, and the effect of enhancing magnetic characteristics such as PW50 is lowered.

In contrast, when Bsδ exceeds the above range, leakage magnetic flux which reaches a magnetic head becomes insufficient during reproduction, so that reproduction output is lowered. The meaning of the “leakage magnetic flux” is the magnetic flux which leaks from the recorded portion of the magnetic recording medium.

Bsδ of the soft magnetic film 2 is 1/3 to 3 times (preferably 1/2 times to twice) the product of residual magnetization and film thickness (Brδ) of the magnetic film 5.

When Bsδ is below the above range, the magnetization of the soft magnetic film 2 becomes relatively lower than that of the magnetic film 5, and the effect of enhancing magnetic characteristics such as PW50 is lowered.

In contrast, when Bsδ exceeds the above range, the magnetization of the soft magnetic film 2 becomes relatively higher than that of the magnetic film 5, and leakage magnetic flux which reaches a magnetic head becomes insufficient during reproduction, so that reproduction output is lowered.

The thickness (overall thickness) of the soft magnetic film 2 is preferably 5-30 nm, more preferably 7-20 nm.

When the thickness is below the above range, the magnetization of the soft magnetic film 2 becomes unsatisfactory, and the effect of enhancing magnetic characteristics such as PW50 is lowered.

In contrast, when the thickness exceeds the above range, leakage magnetic flux which reaches a magnetic head becomes insufficient during reproduction, so that reproduction output is lowered.

Preferably, the soft magnetic film 2 is magnetically isotropic. When the magnetic anisotropy of the soft magnetic film 2 is high, noise such as spike noise is generated easily, and error rate may be impaired.

Therefore, the soft magnetic layer 2a is preferably formed from an amorphous alloy.

The crystal-structure-regulating film 3 has a function of regulating the crystal-structure of a film provided directly on the film 3, and the film 3 is preferably formed from an Ni-alloy, particularly, an NiP-based alloy (e.g., NiP) or an NiAl-based alloy (e.g., NiAl).

The NiP-based alloy may be an alloy containing NiP and other elements (e.g., one or more elements of Cr, Mo, Si, Mn, W, Nb, Ti, and Zr), so long as such “other elements” do not impede the function of NiP; and the NiAl-based alloy may be an alloy containing NiAl and other elements (e.g., one or more elements of Cr, Mo, Si, Mn, W, Nb, Ti, and Zr), so long as such “other elements” do not impede the function of NiAl.

When the crystal-structure-regulating film 3 is formed from an NiP-based alloy, the film 3 is preferably subjected to texturing such as mechanical texturing by use of lapping tape containing fixed abrasive grains or by use of free abrasive grains.

When the crystal-structure-regulating film 3 is subjected to texturing, texture lines formed on surface of the film 3 preferably run along the circumferential direction of the substrate.

In this case, the average surface roughness (Ra) of the crystal-structure-regulating film 3 is preferably 0.5 nm or less, more preferably 0.3 nm or less. When the average surface roughness (Ra) exceeds the above range, the evenness of the medium is lowered, resulting in poor glide height characteristics.

In contrast, when the average surface roughness (Ra) is very small, the crystal-structure-regulating film 3 becomes excessively smooth, and thus the effect of enhancing the magnetic anisotropy of the magnetic film 5 is lowered. Therefore, the average surface roughness (Ra) is preferably at least 0.05 nm.

When the crystal-structure-regulating film 3 is very thick, the distance between the soft magnetic film 2 and the magnetic film 5 becomes very large, and thus the effect of enhancing magnetic characteristics such as PW50 is lowered. Therefore, the thickness of the film 3 is preferably 50 nm or less.

When the crystal-structure-regulating film 3 is formed from an NiP-based alloy, the P content of the alloy is preferably 15-25 at%. When the P content is below the above range, the NiP-based alloy is easily crystallized, and the film 3 adversely affects the crystal orientation of the non-magnetic undercoat film 4 and the magnetic film 5 and may cause lowering of the magnetic anisotropy of the magnetic film 5.

In contrast, when the P content exceeds the above range, the crystal orientation of the non-magnetic undercoat film 4 and the magnetic film 5 is impaired, and the magnetic anisotropy of the magnetic film 5 is easily lowered.

When the crystal-structure-regulating film 3 is formed from an NiAl-based alloy, the Al content of the alloy is preferably 45-55 at%. When the Al content is below or exceeds the above range, the crystal orientation of the non-magnetic undercoat film 4 and the magnetic film 5, which are formed on the film 3, is impaired.

The non-magnetic undercoat film 4 may be formed from conventionally known materials for undercoat film. For example, the film 4 may be formed from an alloy of one or more elements of Cr, Ti, Ni, Si, Ta, W, Mo, V, and Nb. Alternatively, the film 4 may be formed from an alloy of one or more of the above elements and other elements, so long as such “other elements” do not impede the crystallinity of the film.

Particularly, the film 4 is preferably formed from Cr or a Cr alloy (e.g., a CrTi-, CrW-, CrMo-, CrV-, or CrSi-based alloy).

The thickness of the non-magnetic undercoat film 4 is preferably 1-100 nm, more preferably 2-50 nm.

The non-magnetic undercoat film 4 may have a single-layer structure or a multi-layer structure.

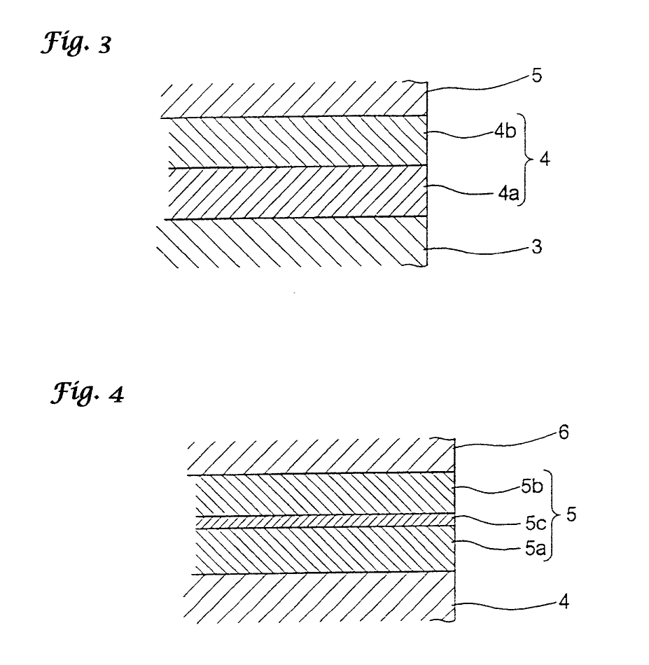

For example, as shown in FIG. 3, the non-magnetic undercoat film 4 may have a two-layer structure including a first undercoat film 4a and a second undercoat film 4b formed on the film 4a.

The magnetic film 5 is preferably formed from a magnetic material containing Co. The material may be, for example, a Co alloy containing Co and one or more elements of Cr, Pt, Ta, B, Ti, Ag, Cu, Al, Au, W, Nb, Zr, V, Ni, Fe, and Mo.

Preferred specific examples of the above material include CoCr-, CoPt-, CoCrPt-, CoCrPtTa-, CoCrPtB-, CoCrPtBTa-, CoCrPtTaCu-, CoCrPtTaZr-, CoCrPtTaW-, CoCrPtCu-, CoCrPtZr-, CoCrPtBCu-, CoCrPtBZr-, CoNiTa-, CoNiTaCr-, and CoCrTa-based alloys.

The magnetic film 5 may have a single-layer structure or the below-described antiferromagnetic bonding structure (so-called AFC (Anti Ferro Coupling) structure).

As shown in FIG. 4, the magnetic film 5 includes first and second magnetic layers 5a and 5b, and an antiferromagnetic layer 5c provided between the layers 5a and 5b.

The first and second magnetic layers 5a and 5b may be formed from the aforementioned magnetic material for magnetic film 5.

The antiferromagnetic layer 5c may be formed from an antiferromagnetic material such as Ru.

The magnetic film 5 is formed such that, when the film 5 is magnetized, the magnetization direction of the first magnetic layer 5a becomes opposite or the same as that of the second magnetic layer 5b. When the thickness is less than about 50 Å, the direction of magnetization is opposite. When the thickness exceeds the value, the direction of magnatization is the same.

When the first magnetic layer 5a (the lower layer) is excessively thick, the magnetization direction of the layer 5a is not necessarily aligned opposite the magnetization direction of the second magnetic layer 5b; i.e., the magnetization direction of the layer 5a may partially become the same as that of the second magnetic layer 5b. As a result, although reproduction output is enhanced, PW50 is lowered.

Therefore, the thickness of the first magnetic layer 5a is preferably 10 nm or less.

When the first magnetic layer 5a (the lower layer) is very thin, magnetization of the layer becomes unsatisfactory, and antiferromagnetic bonding between the two magnetic layers 5a and 5b becomes unsatisfactory, and thus the effect of enhancing thermal stability is lowered. Therefore, the thickness of the layer 5a is preferably at least 1 nm.

The thickness of the first magnetic layer 5a is preferably determined such that the thickness becomes ⅓ to 3/2 that of the second magnetic layer 5b.

When the thickness of the first magnetic layer 5a is below the above range, magnetization of the layer becomes unsatisfactory, and the effect of enhancing thermal stability is lowered. In contrast, when the thickness exceeds the above range, PW50 is lowered.

The thickness of the second magnetic layer 5b is preferably 6-20 nm, more preferably 8-15 nm.

When the thickness is below the above range, magnetization of the layer 5b becomes unsatisfactory, and the effect of enhancing thermal stability is lowered. In contrast, when the thickness exceeds the above range, magnetization of the layer 5b becomes excessive, and antiferromagnetic bonding between the two magnetic layers 5a and 5b becomes unsatisfactory, with the result that the effect of enhancing thermal stability is lowered.

When the antiferromagnetic layer 5c is formed from Ru, the thickness of the layer 5c is preferably 0.6-1 nm, more preferably 0.7-0.9 nm.

When the thickness of the layer 5c is below or exceeds the above range, antiferromagnetic bonding between the two magnetic layers 5a and 5b becomes unsatisfactory, and thus the effect of enhancing thermal stability is lowered.

The antiferromagnetic layer 5c may be formed from Cr or a Cr alloy. In this case, the thickness of the layer 5c is 2-3 nm, preferably 2.2-2.8 nm. When the thickness is below the above range, the SNR (signal/noise ratio) is lowered, whereas when the thickness exceeds the above range, the crystal orientation of the magnetic film 5 is impaired, which may cause deterioration of magnetic characteristics.

In the present invention, the structure of the magnetic film is not limited to the aforementioned structure; the magnetic film may have a structure including three or more magnetic layers, in which an antiferromagnetic layer is provided between adjacent two magnetic layers.

The protective film 6 may be formed from conventionally known materials. For example, the film may be formed from a material containing a single component such as carbon, silicon oxide, silicon nitride, or zirconium oxide; or a material predominantly containing such components.

The thickness of the protective film 6 is preferably 2-10 nm.

The lubrication film 7 may be formed from a fluorine-containing lubricant such as perfluoropolyether.

An embodiment of the production process for a magnetic recording medium of the present invention will next be described by taking, as an example, production of the aforementioned magnetic recording medium.

Firstly, the soft magnetic film 2 is formed on the non-magnetic substrate 1 through, for example, sputtering.

The soft magnetic film 2 having the multi-layer structure shown in FIG. 2 may be formed through sputtering making use of, alternately, a first sputtering target containing the material of the soft magnetic layer 2a and a second sputtering target containing the material of the non-magnetic layer 2b.

Through the above procedure, the medium substrate M including the non-magnetic substrate 1 and the soft magnetic film 2 formed on the substrate 1 is obtained.

When the crystal-structure-regulating film 3 is formed from an NiAl-based alloy, preferably, the surface of the soft magnetic film 2 is exposed to an oxygen-containing gas (e.g., air, pure oxygen, or oxygen-rich gas).

Through this exposure, the crystal orientation of the crystal-structure-regulating film 3 is strongly influenced of the oxidized surface of the soft magnetic film 2, and thus the crystal-structure-regulating film 3, the non-magnetic undercoat film 4, and the magnetic film 5, which are grown under the effect of the soft magnetic film 2, can be enhanced in crystal orientation.

As a result, magnetic characteristics of the magnetic film 5 can be enhanced.

When the soft magnetic film 2 is exposed to an oxygen-containing gas, preferably, the medium substrate M (including the non-magnetic substrate 1 and the soft magnetic film 2 formed on the substrate 1) is heated so as to subject the film 2 to heat treatment. This heat treatment maybe carried out at 100-270° C.

Through this heat treatment, the crystal-structure-regulating film 3, the non-magnetic undercoat film 4, and the magnetic film 5 can be further enhanced in crystal orientation.

Subsequently, the crystal-structure-regulating film 3 is formed on the soft magnetic film 2 through, for example, sputtering.

When the crystal-structure-regulating film 3 is formed from an NiP-based alloy, the film 3 is formed through sputtering at 100° C. or lower, preferably at 80° C. or lower.

When the temperature exceeds the above range, the NiP-based alloy is easily crystallized, and thus the film 3 adversely affects the crystal orientation of the non-magnetic undercoat film 4 and the magnetic film 5, and may cause lowering of the magnetic anisotropy of the magnetic film 5.

When the crystal-structure-regulating film 3 is formed from an NiP-based alloy, preferably, the surface of the film 3 is subjected to texturing such as mechanical texturing by use of lapping tape containing fixed abrasive grains or by use of free abrasive grains.

When the crystal-structure-regulating film 3 is formed, the material of the film 3 is deposited onto the soft magnetic film 2 such that the thickness of the deposition film becomes slightly greater than the target thickness of the film 3, and then the deposition film is subjected to texturing so as to attain the target thickness of the film 3 (e.g., 5 nm or less).

Prior to texturing, the surface of the crystal-structure-regulating film 3 is preferably washed with water.

Also, after texturing, the surface of the crystal-structure-regulating film 3 is preferably washed with water.

When the crystal-structure-regulating film 3 is formed from an NiP-based alloy, preferably, the surface of the film 3 is exposed to an oxygen-containing gas (e.g., air, pure oxygen, or oxygen-rich gas).

Through the above-mentioned process, the non-magnetic undercoat film 4 and the magnetic film 5, which are grown under the effect of the crystal-structure-regulating film 3, can be enhanced in crystal orientation. As a result, magnetic characteristics of the magnetic film 5 can be enhanced.

When the crystal-structure-regulating film 3 is formed from an NiP-based alloy, preferably, the disk (including the non-magnetic substrate 1, the soft magnetic film 2, and the crystal-structure-regulating film 3, the films being formed on the substrate 1) is heated so as to subject the film 3 to heat treatment. This heat treatment maybe carried out at 100-270° C.

Through this heat treatment, the non-magnetic undercoat film 4 and the magnetic film 5 can be further enhanced in crystal orientation.

Subsequently, the non-magnetic undercoat film 4 is formed on the crystal-structure-regulating film 3, and then the magnetic film 5 is formed on the film 4. The non-magnetic undercoat film 4 and the magnetic film 5 may be formed through sputtering.

Subsequently, the protective film 6 is formed on the magnetic film 5. The protective film 6 may be formed through, for example, plasma CVD or sputtering.

Subsequently, the lubrication film 7 is formed on the protective film 6 through, for example, dipping.

Through the above-described procedure, the magnetic recording medium shown in FIG. 1 is produced.

Since the magnetic recording medium of the embodiment of FIG. 1 includes the soft magnetic film 2 provided between the non-magnetic substrate 1 and the crystal-structure-regulating film 3, the distance between the magnetic film 5 and a magnetic head (i.e., spacing loss) can be seemingly reduced during recording or reproduction of data, and thus high recording density is easily attained.

Since the soft magnetic film 2 is provided below the crystal-structure-regulating film 3, which directly affects crystal growth of the non-magnetic undercoat film 4 and the magnetic film 5, adverse effects of the soft magnetic film 2 on crystal growth of the non-magnetic undercoat film 4 and the magnetic film 5 can be prevented.

As a result, magnetic characteristics of the magnetic film 5 can be enhanced.

Therefore, the magnetic recording medium exhibits excellent magnetic characteristics.

Provision of the soft magnetic film 2 can enhance magnetic characteristics such as PW50.

The reason for the above; i.e., magnetic characteristics such as PW50 can be enhanced by providing the soft magnetic film 2 is thought to be as follows: downward magnetization from the magnetic film 5 toward the soft magnetic film 2 occurs in the presence of the soft magnetic film 2, and a portion of the upward (i.e., toward the upper surface of the medium) magnetic flux from the magnetic film 5 is cancelled, resulting in a narrowed magnetic transition width.

Since the soft magnetic film 2 has a multi-layer structure containing a plurality of the soft magnetic layers 2a and a plurality of the non-magnetic layers 2b, the thickness of the soft magnetic layer 2a can be reduced.

As a result, movement of magnetic domain walls in the soft magnetic layer 2a can be prevented, and generation of spike noise can be prevented.

Since the magnetic film 5 includes the first and second magnetic layers 5a and 5b and the antiferromagnetic layer 5c provided between the layers 5a and 5b ; i.e., since the magnetic film 5c has an AFC structure, thermal stability can be enhanced.

In general, when a magnetic film has an AFC structure, although thermal stability is enhanced, PW50 is impaired if attainment of sufficient output is intended.

In contrast, in the magnetic recording medium of the embodiment of FIG. 1, both thermal stability and PW50 can be enhanced, since PW50 can be improved by providing the soft magnetic film 2.

In the production process of the magnetic recording mmedium of the embodiment of FIG. 1, the soft magnetic film 2 is provided between the non-magnetic substrate 1 and the crystal-structure-regulating film 3. Therefore, high recording density is easily attained, and the magnetic recording medium exhibits excellent magnetic characteristics.

Since the medium substrate M used in the magnetic recording medium of the embodiment of FIG. 1 includes the non-magnetic substrate 1 and the soft magnetic film 2 formed on the substrate 1, high recording density is easily attained, and the magnetic recording medium exhibits excellent magnetic characteristics.

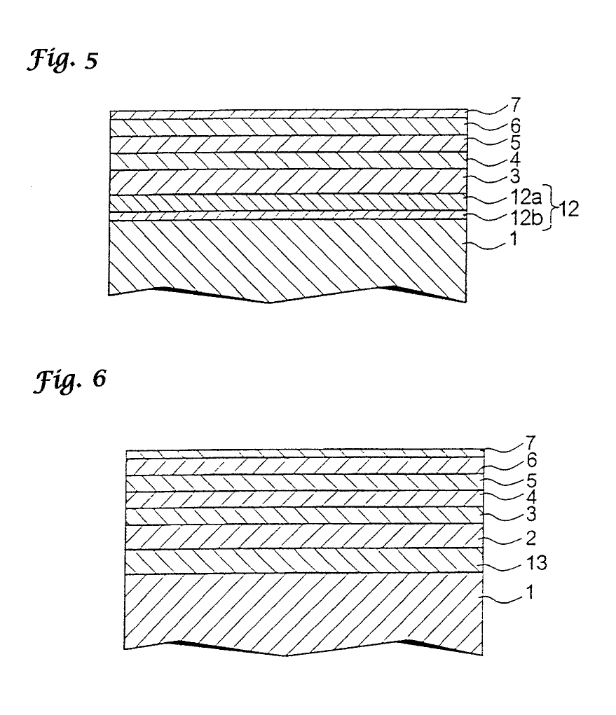

FIG. 5 shows another embodiment of the magnetic recording medium of the present invention. The magnetic recording medium shown in FIG. 5 differs from the magnetic recording medium having the structure shown in FIG. 1, in that a soft magnetic film 12 includes a hard magnetic layer 12b and a hard magnetic layer 12a provided on the layer 12b.

The soft magnetic layer 12a may be formed from the soft magnetic material described above as the material of the soft magnetic layer 2a . The soft magnetic layer 12a is preferably similar to the soft magnetic layer 2a in coercive force (Hc) and the product of saturated magnetization and film thickness (Bsδ).

The thickness of the soft magnetic layer 12a is preferably 5-30 nm, more preferably 7-20 nm.

When the thickness is below the above range, magnetization of the soft magnetic film 12 becomes unsatisfactory, and the effect of enhancing magnetic characteristics such as PW50 is lowered.

In contrast, when the thickness exceeds the above range, leakage magnetic flux which reaches a magnetic head becomes unsatisfactory during reproduction, and reproduction output is lowered.

The product of saturated magnetization and film thickness (Bsδ) of the soft magnetic layer 12a is preferably 20-100 Gμm, more preferably 30-70 Gμm.

When Bsδ is below the above range, magnetization of the soft magnetic film 2 becomes unsatisfactory, and the effect of enhancing magnetic characteristics such as PW50 is lowered.

In contrast, when Bsδ exceeds the above range, leakage magnetic flux which reaches a magnetic head becomes unsatisfactory during reproduction, and reproduction output is lowered.

The hard magnetic layer 12b may be formed from a CoSm-based alloy or a CoCrPtCr-based alloy.

The hard magnetic layer 12b is formed from a material having a coercive force (Hc) preferably of at least 500 (Oe) (more preferably at least 1,000 (Oe)).

When the coercive force (Hc) is below the above range, noise such as spike noise is generated easily.

The thickness of the hard magnetic layer 12b is preferably 1-10 nm, more preferably 2-7 nm.

When the thickness of the layer 12b is below the above range, stability of magnetization in the soft magnetic layer 12a is lowered and magnetic domain walls move easily in the layer 12a , with the result that spike noise is generated easily.

In contrast, when the thickness of the layer 12b exceeds the above range, magnetic characteristics such as PW50 are deteriorated.

In the magnetic recording medium of the embodiment shown in FIG. 5, magnetization in the soft magnetic layer 12a is stabilized by the hard magnetic layer 12b , movement of magnetic domain walls in the layer 12a is suppressed, and spike noise can be reduced.

In the aforementioned embodiment of FIG. 5, the soft magnetic film 12 has a multi-layer structure. However, the soft magnetic film may have a single-layer structure. In this case, the soft magnetic film may be formed from the soft magnetic material described above as the material of the soft magnetic layer 12a.

FIG. 6 shows yet another embodiment of the magnetic recording medium of the present invention.

When the non-magnetic substrate 1 is a non-metallic substrate formed from a non-metallic material such as glass, preferably, a diffusion preventive film 13 for preventing diffusion of the material of the non-magnetic substrate 1 (e.g., oxygen) into the soft magnetic film 2 is provided between the non-magnetic substrate 1 and the soft magnetic film 2.

The diffusion preventive film 13 may be formed from one or more elements of Cr, Co, Ni, Si, B, Al, Zr, Ti, Ta, Nb, and W.

For example, the film 13 may be formed from a Co alloy containing Co and one or more elements of Si, B, Al, Zr, Ti, Ta, Nb, and W.

Alternatively, the film 13 may be formed from a Cr alloy containing Cr and one or more elements of Si, B, Al, Zr, Ti, Ta, Nb, and W.

Alternatively, the film 13 may be formed from an Ni alloy containing Ni and one or more elements of Si, B, Al, Zr, Ti, Ta, Nb, and W.

Particularly, the film 13 is preferably formed from a CrTa-based alloy (e.g., CrTa containing Ta in an amount of 30-50 at%).

The diffusion preventive film 13 is preferably formed from an amorphous material, since the effect of preventing invasion of the material of the substrate into the soft magnetic film 2 can be enhanced.

When the diffusion preventive film 13 is very thin, the material of the substrate 1 (particularly oxygen) is diffused via the film 13 into the soft magnetic film 2, and the material adversely affects properties of the film 2 and may cause deterioration of magnetic characteristics.

Therefore, the thickness of the diffusion preventive film 13 is preferably at least 5 nm, more preferably at least 7 nm.

From the viewpoint of production efficiency, the thickness of the diffusion preventive film 13 is preferably 20 nm or less.

Provision of the diffusion preventive film 13 can prevent invasion of the material of the substrate (e.g., oxygen) into the soft magnetic film 2 and change in properties of the film 2.

Therefore, even when the non-magnetic substrate 1 is a non-metallic substrate such as a glass substrate, deterioration of magnetic characteristics can be prevented.

Since invasion of the material of the substrate into the soft magnetic film 2 can be prevented, even when the thickness of the lowermost soft magnetic layer 2a is reduced, sufficient magnetization can be obtained. Therefore, the thickness of the layer 2a can be determined arbitrarily. Thus, the thickness of the lowermost soft magnetic layer 2a is easily determined to a level required for obtaining intended magnetic characteristics.

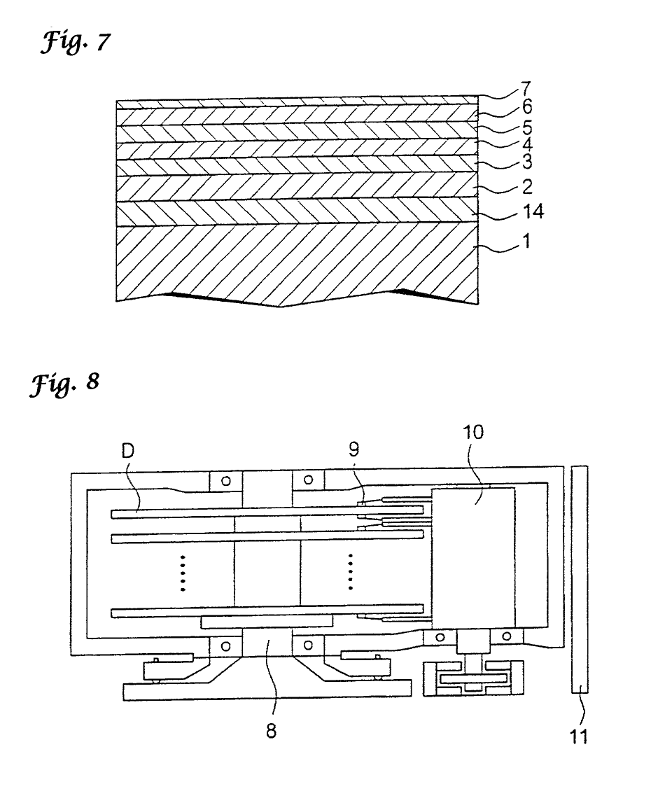

As shown in FIG. 7, when the crystal-structure-regulating film 3 is formed from an NiAl-based alloy, an orientation-determining film 14 formed from a material which can determine the crystal orientation of the NiAl-based alloy (for example, a material which can make the crystal orientation plane of NiAl assume a (112) plane) may be provided between the soft magnetic film 2 and the crystal-structure-regulating film 3.

The material of the film 14 may be a crystalline material or an amorphous material, but an amorphous material is preferred.

The material of the film 14 may be a CrTa-based alloy (e.g., Cr35Ta), a CoZr-based alloy (e.g., Co66Zr), or a CrSi-based alloy (e.g., Cr30Si).

By provision of the orientation-determining film 14, the crystal orientation of the crystal-structure-regulating film 3 is essentially arranged in one direction, and the non-magnetic undercoat film 4 and the magnetic film 5, which are grown under the effect of the film 3, can be enhanced in crystal orientation.

As a result, magnetic characteristics of the magnetic film 5 are enhanced, and the magnetic recording medium exhibits excellent magnetic characteristics.

FIG. 8 shows an embodiment of the magnetic recording and reproducing apparatus including the aforementioned magnetic recording medium. The apparatus includes a magnetic recording medium D, the structure of the medium being shown in any one of FIGS. 1 through 7; a medium-driving portion 8 which rotates the medium D; a magnetic head 9 which is employed for recording of data onto the medium D and for reproduction of the data therefrom; a head-driving portion 10; and a recorded/reproduced signal-processing system 11.

In the recorded/reproduced signal-processing system 11, incoming external signals are processed and sent to the magnetic head 9, or reproduction signals from the head 9 are processed and output to the outside.

When the magnetic recording and reproducing apparatus is employed, recording density can be increased, since magnetic characteristics of the magnetic recording medium D can be enhanced. In addition, problems, including loss of recorded data which is attributed to thermal decay, can be obviated.

In the present invention, a non-magnetic intermediate film may be provided between the non-magnetic undercoat film 4 and the magnetic film 5. The non-magnetic intermediate film is preferably formed from a Co alloy. The intermediate film may be formed from a Co alloy containing one or more elements of Cr, Ti, Ni, Si, Ta, W, Mo, V, and Nb. Particularly, the intermediate film is preferably formed from a CoCr-based alloy (particularly a CoCr-based alloy containing Cr in an amount of 30-40 at%).

The thickness of the non-magnetic intermediate film preferably is 1-10 nm, more preferably 2-5 nm.

### EXAMPLES

### Example 1

The magnetic recording medium shown in FIG. 1 was produced as follows.

On a glass substrate 1 having an amorphous structure (diameter: 65 mm, thickness: 0.635 mm), a soft magnetic film 2 was formed through sputtering by use of a DC magnetron sputtering apparatus (Model 3010, product of ANELVA, Japan).

Subsequently, a crystal-structure-regulating film 3 was formed on the film 2 through sputtering, and the surface of the film 3 was subjected to texturing.

Subsequently, the thus-produced disk (including the substrate 1 and the films 2 and 3 formed on the substrate 1) was heated (thermally treated) at 200° C. Thereafter, a non-magnetic undercoat film 4, a magnetic film 5, and a protective film 6 were successively formed on the film 3 through sputtering. On the protective film 6, a perfluoropolyether lubrication film 7 was formed through dipping, to thereby produce a magnetic recording medium.

Read-write conversion characteristics of the thus-produced magnetic recording medium were measured by use of read/write analyzer RWA1632 and spin stand S1701MP (products of GUZIK, U.S.A.). In order to evaluate read-write conversion characteristics, measurement was performed by use of, as a magnetic head, a complex-type thin film magnetic recording head containing a giant magnetoresistive (GMR) element at the reproduction portion, and track-recording density was set at 525 KFCI.

The test results are shown in Table 1.

### Examples 2 to 9

Magnetic recording media were produced under the conditions shown in Tables 1 and 2. The media were produced in a manner similar to that of Example 1.

The test results are shown in Tables 1 and 2.

TABLE 1

| | | Soft magnetic film | | | | | | | | | | | | | |
|---|---|---|---|---|---|---|---|---|---|---|---|---|---|---|---|
| | | Non-magnetic | | Soft magnetic | | Non-magnetic | | Soft magnetic | | Non-magnetic | | Soft magnetic | | Non-magnetic | |
| | | layer | | layer | | layer | | layer | | layer | | layer | | layer | |
| | Sub- | Compo- | Thick- | Compo- | Thick- | Compo- | Thick- | Compo- | Thick- | Compo- | Thick- | Compo- | Thick- | Compo- | Thick- |
| | strate | sition | ness | sition | ness | sition | ness | sition | ness | sition | ness | sition | ness | sition | ness |
| Ex. 1 | Glass | | | Co33Zr | 20 | | | | | | | | | | |
| Ex. 2 | Glass | | | Co33Zr | 7 | Co66Zr | 2 | Co33Zr | 7 | Co66Zr | 2 | Co33Zr | 7 | | |
| Ex. 3 | Glass | Cr35Ta | 30 | Co33Zr | 7 | Co66Zr | 2 | Co33Zr | 7 | Co66Zr | 2 | Co33Zr | 7 | | |
| Ex. 4 | Glass | Cr35Ta | 30 | Co33Zr | 7 | Co66Zr | 2 | Co33Zr | 7 | Co66Zr | 2 | Co33Zr | 7 | Cr35Ta | 5 |
| Ex. 5 | Glass | Cr35Ta | 30 | Co33Zr | 7 | Co66Zr | 2 | Co33Zr | 7 | Co66Zr | 2 | Co33Zr | 7 | Cr35Ta | 5 |
| Comp. | Glass | | | | | | | | | | | | | | |
| Ex. 1 | | | | | | | | | | | | | | | |
| Comp. | Glass | | | Co33Zr | 20 | | | | | | | | | | |
| Ex. 2 | | | | | | | | | | | | | | | |
| Comp. | Glass | Co35Ta | 30 | | | | | | | | | | | | |
| Ex. 3 | | | | | | | | | | | | | | | |

| | | | Crystal-structure- | | | | | | | | | |
|---|---|---|---|---|---|---|---|---|---|---|---|---|
| | | | regulating film | | | | Non-magnetic undercoat film | | | | | |
| | Heat | O₂ | Compo- | Thick- | Texturing | Heat | Compo- | Thick- | Compo- | Thick- | Magnetic film | |
| | treatment | exposure | sition | ness | *1 | treatment *2 | sition | ness | sition | ness | Composition | Thickness |
| Ex. 1 | — | — | NiP | 50 | Yes | Yes | Cr | 10 | Cr20Mo | 5 | Co22Cr12Pt6B | 18 |
| Ex. 2 | — | — | NiP | 50 | Yes | Yes | Cr | 10 | Cr20Mo | 5 | Co22Cr12Pt6B | 18 |
| Ex. 3 | — | — | NiP | 50 | Yes | Yes | Cr | 10 | Cr20Mo | 5 | Co22Cr12Pt6B | 18 |
| Ex. 4 | — | — | NiP | 50 | Yes | Yes | Cr | 10 | Cr20Mo | 5 | Co22Cr12Pt6B | 18 |
| Ex. 5 | — | — | NiP | 50 | Yes | Yes | Cr | 8 | Cr15V | 20 | *3 | |
| Comp. | — | — | NiP | 50 | Yes | Yes | Cr | 10 | Cr20Mo | 5 | Co22Cr12Pt6B | 18 |
| Ex. 1 | | | | | | | | | | | | |
| Comp. | — | — | NiP | 150 | Yes | Yes | Cr | 10 | Cr20Mo | 5 | Co22Cr12Pt6B | 18 |
| Ex 2 | | | | | | | | | | | | |
| Comp. | — | — | NiP | 50 | Yes | Yes | Cr | 8 | Cr15Vo | 20 | *3 | |
| Ex. 3 | | | | | | | | | | | | |

(Thickness unit: nm)
*1 Texturing was carried out such that the average surface roughness (Ra) of the crystal-structure-regulating film was 0.3 nm.
*2 Heat treatment was carried out at 200° C.
*3 Co25Cr (2.5 nm)/Ru (0.8 nm)/Co22Cr12Pt6B (9 nm)/Ru (0.8 nm)/Co22Cr12Pt6B (7 nm)/Co16Cr8Pt8B (4 nm)
*In Examples 1 through 4 and Comparative Examples 1 and 2, a non-magnetic intermediate film of Co35Cr (thickness: 2 nm) was formed between the non-magnetic undercoat film and the magnetic film.

| | TAA (LF) (μV) | OW (dB) | PW50 (ns) | SNR (dB) | Note |
|---|---|---|---|---|---|
| Ex. 1 | 1235 | 33 | 9.64 | 17.3 | Slight spike noise was observed |
| Ex. 2 | 1197 | 32 | 9.59 | 17.5 | No spike noise was observed |
| Ex. 3 | 1150 | 32 | 9.57 | 17.5 | No spike noise was observed |
| Ex. 4 | 1210 | 33 | 9.6 | 17.6 | No spike noise was observed |
| Ex. 5 | 1580 | 29 | 10.3 | 20.6 | |
| Comp. Ex. 1 | 1537 | 38 | 10.7 | 17.6 | No spike noise was observed |
| Comp. Ex. 2 | 1227 | 33 | 9.63 | 17.4 | Deep abrasive scars were prone to remain on the crystal-structure-regulating |
| | | | | | film during texturing, and the yield was low. |
| Comp. Ex. 3 | 1844 | 34 | 11.3 | 20.8 | |

TAA (LF): Reproduction output signal (low frequency)
OW: Overwrite characteristics
PW50: Half power width of isolated read pulse
SNR: Signal/noise ratio

TABLE 2

| | | Soft magnetic film | | | | | | | | | | | | | |
|---|---|---|---|---|---|---|---|---|---|---|---|---|---|---|---|
| | | Non-magnetic | | Soft magnetic | | Non-magnetic | | Soft magnetic | | Non-magnetic | | Soft magnetic | | Non-magnetic | |
| | | layer | | layer | | layer | | layer | | layer | | layer | | layer | |
| | Sub- | Compo- | Thick- | Compo- | Thick- | Compo- | Thick- | Compo- | Thick- | Compo- | Thick- | Compo- | Thick- | Compo- | Thick- |
| | strate | sition | ness | sition | ness | sition | ness | sition | ness | sition | ness | sition | ness | sition | ness |
| Ex. 6 | Glass | | | Co33Zr | 20 | Cr35Ta | 5 | | | | | | | | |
| Ex. 7 | Glass | | | Co33Zr | 7 | Co66Zr | 2 | Co33Zr | 7 | Co66Zr | 2 | Co33Zr | 7 | Cr35Ta | 5 |
| Ex. 8 | Glass | Cr35Ta | 5 | Co33Zr | 7 | Co66Zr | 2 | Co33Zr | 7 | Co66Zr | 2 | Co33Zr | 7 | | |
| Ex. 9 | Glass | Cr35Ta | 5 | Co33Zr | 7 | Co66Zr | 2 | Co33Zr | 7 | Co66Zr | 2 | Co33Zr | 7 | Cr35Ta | 5 |
| Comp. | Glass | | | | | | | | | | | | | | |
| Ex. 4 | | | | | | | | | | | | | | | |

| | | | Crystal-structure- | | | | Non-magnetic | | | |
|---|---|---|---|---|---|---|---|---|---|---|
| | Heat | O₂ | regulating film | | | Heat | undercoat film | | Magnetic film | |
| | treatment *4 | exposure *5 | Composition | Thickness | Texturing | treatment | Composition | Thickness | Composition | Thickness |
| Ex. 6 | Yes | Yes | NiAl | 30 | — | — | Cr20Mo | 15 | Co22Cr10Pt4B | 20 |
| Ex. 7 | Yes | Yes | NiAl | 30 | — | — | Cr20Mo | 15 | Co22Cr10Pt4B | 20 |
| Ex. 8 | Yes | Yes | NiAl | 30 | — | — | Cr20Mo | 15 | Co22Cr10Pt4B | 20 |
| Ex. 9 | Yes | Yes | NiAl | 30 | — | — | Cr20Mo | 15 | Co22Cr10Pt4B | 20 |
| Comp. Ex. 4 | Yes | Yes | NiAl | 50 | — | — | Cr20Mo | 15 | Co22Cr10Pt4B | 20 |

(Thickness unit: nm)
*4 Heat treatment was carried out at 180° C.
*5 Pure oxygen was introduced into the chamber of the sputtering apparatus.
*In Examples 6 through 9 and Comparative Example 4, a non-magnetic intermediate film of Co35Cr (thickness: 2 nm) was formed between the non-magnetic undercoat film and the magnetic film.

| | TAA (LF) (μV) | OW (dB) | PW50 (ns) | SNR (dB) | Note |
|---|---|---|---|---|---|
| Ex. 6 | 1069 | 36 | 10.4 | 16.4 | Slight spike noise was observed |
| Ex. 7 | 1087 | 37 | 10 5 | 16 6 | No spike noise was observed |
| Ex. 8 | 1032 | 37 | 10.5 | 16.7 | No spike noise was observed |
| Ex. 9 | 1043 | 37 | 10.4 | 16.7 | No spike noise was observed |
| Comp. Ex. 4 | | | | | |

TAA (LF): Reproduction output signal (low frequency)
OW: Overwrite characteristics
PW50: Half power width of isolated read pulse
SNR: Signal/noise ratio

As is apparent from Tables 1 and 2, a magnetic recording medium exhibiting excellent magnetic characteristics can be produced by providing the soft magnetic film 2.

As described above, since the magnetic recording medium of the present invention includes a soft magnetic film provided between a non-magnetic substrate and a crystal-structure-regulating film, the distance between the magnetic film and a magnetic head can be seemingly reduced, and high recording density is easily attained.

Since the soft magnetic film is provided below the crystal-structure-regulating film, which directly affects crystal growth of a non-magnetic undercoat film and a magnetic film, adverse effects of the soft magnetic film on crystal growth of the non-magnetic undercoat film and the magnetic film can be prevented.

As a result, magnetic characteristics of the magnetic film are enhanced, and the magnetic recording medium exhibits excellent magnetic characteristics. Particularly, magnetic characteristics such as PW50 can be enhanced.

While the invention has been described in detail and with reference to specific embodiments thereof, it will be apparent to one skilled in the art that various changes and modifications can be made therein without departing from the spirit and scope thereof.

What is claimed is:

1. A magnetic recording medium comprising a non-magnetic substrate; a crystal-structure-regulating film) formed thereon, which film regulates the crystal structure of a film provided directly on the crystal-structure-regulating film; a non-magnetic undercoat film and a magnetic film which are formed on the crystal-structure-regulating film; and
a soft magnetic film provided between the non-magnetic substrate and the crystal-structure-regulating film.

2. A magnetic recording medium according to claim 1, wherein the crystal-structure-regulating film is formed from NiP or NiAl.

3. A magnetic recording medium according to claim 1 or 2, wherein the soft magnetic film has a multi-layer structure containing a plurality of soft magnetic layers and a plurality of non-magnetic layers.

4. A magnetic recording medium according to claim 1 or 2, wherein the soft magnetic film contains a soft magnetic layer and a hard magnetic layer.

5. A magnetic recording medium according to any one of claims 1 or 2, wherein the non-magnetic substrate is formed from a non-metallic material, and a diffusion preventive film for preventing diffusion of the material of the non-magnetic substrate into the soft magnetic film is provided between the non-magnetic substrate and the soft magnetic film.

6. A magnetic recording medium according to claim 5, wherein the diffusion preventive film has an amorphous structure.

7. A process for producing a magnetic recording medium comprising forming a crystal-structure-regulating film on a non-magnetic substrate;
forming a non-magnetic undercoat film and a magnetic film on the crystal-structure-regulating film, and
providing a soft magnetic film between the non-magnetic substrate and the crystal-structure-regulating film.

8. A magnetic recording and reproducing apparatus comprising a magnetic recording medium and a magnetic head for recording data onto the medium and reproducing the data therefrom,
wherein the magnetic recording medium comprises a non-magnetic substrate; a crystal-structure-regulating film formed thereon, which film regulates the crystal structure of a film provided directly on the crystal-structure-regulating film; a non-magnetic undercoat film and a magnetic film formed on the crystal-structure-regulating film; and a soft magnetic film provided between the non-magnetic substrate and the crystal-structure-regulating film.

9. A medium substrate comprising a non-magnetic substrate and a soft magnetic film provided thereon.
